(19) United States
(12) Patent Application Publication
(10) Pub. No.: US 2006/0036412 A1
(43) Pub. Date: Feb. 16, 2006

(54) Check indicator for computer-aided drafting (CAD)

(76) Inventor: Hiromichi Takatsuka, Fujisawa-city (JP)

Correspondence Address: LAW OFFICES OF MICHAEL DRYJA, 704 228TH AVENUE NE, PMB 694, SAMMAMISH, WA, 98074, US

(21) Appl. No.: 10/919,505

(22) Filed: Aug. 15, 2004

(51) Int. Cl. G06F 19/00

(52) U.S. Cl. 703/1; 700/97

(57) ABSTRACT

Check indicators within a computer-aided drafting (CAD) system are disclosed. A method of an embodiment first displays in a highlighted manner a change to an element of a CAD design. A check indicator is displayed that denotes whether the change to the element has been reviewed. A user is permitted to check the check indicator to denote that the change to the element has been reviewed. A dynamically updated completion ratio of check indicators that have been checked by the user may be displayed, which are deleted upon approval of the design. The completion ratio and the changes may be stored, and the check indicators displayed within a master checklist. When a simulation of the CAD design is executed, the check indicators may be integrated with the results of the simulation. The changes to which the check indicators correspond may be initiated by the user, or by the simulation.

### FIELD OF THE INVENTION

The present invention relates generally to computer-aided drafting (CAD), and more particularly to facilitating the review of CAD design elements via check indicators.

### BACKGROUND OF THE INVENTION

Computer-aided drafting (CAD) is generally the use of computers to assist in designing products. CAD systems are typically high-speed workstations or desktop computers with CAD software. A graphics tablet may be used for drawing, and a scanner may be attached for additional input. The output of a CAD system is either printed or electronically transmitted to a computer-aided modeling (CAM) system, which builds the objects, or to a computer-aided engineering (CAE) system, which may simulate the objects. As used herein, CAD is substantially synonymous with CAE and CAM, as well as with computer-aided design (CAD). That is, the terminology CAD is meant to be construed generally herein.

One ultimate goal of CAD is to completely banish paper from the design process —that is, to have design become a paperless process. However, paperless design using CAD has become a difficult goal to realize. One reason is that designers are accustomed and acculturated to using hardcopies of designs for certain parts of the design process. For instance, when drawings are being checked, or reviewed or verified, they are usually output as hardcopy. The hardcopies are then typically marked up with modifications, and the modifications may then be reentered into the CAD system being utilized.

However, having such hardcopies present in the design process deters achievement of the goal of paperless design. Additionally, the marking up of paper copies of a design can introduce opportunities for errors to be made in the design process, such as if modifications entered on the paper copies of the design are not properly entered back into the CAD system, and so on. For these and other reasons, therefore, there is a need for the present invention.

### SUMMARY OF THE INVENTION

The invention relates to check indicators within a computer-aided drafting (CAD) system. A method of an embodiment first displays in a highlighted manner a change to an element of a CAD design. A check indicator is displayed that denotes whether the change to the element has been reviewed. A user is permitted to check the check indicator to denote that the change to the element has been reviewed. Furthermore, preferably a dynamically updated completion ratio of check indicators that have been checked by the user is displayed, which are then deleted from the CAD design upon approval of the design. The completion ratio and the changes may be stored, and the check indicators displayed within a master checklist. When a simulation of the CAD design is executed, the check indicators may be integrated with the results of the simulation. The changes to which the check indicators correspond may be initiated by the user, or by the simulation.

A CAD system of one embodiment of the invention includes an editing mechanism and a simulation mechanism. The editing mechanism allows for adding, deleting, and modifying elements of a CAD design. The editing mechanism displays changes to the elements in a highlighted manner, and displays user-checkable check indicators corresponding to the changes that denote whether the changes have been user reviewed. The simulation mechanism allows for simulation of the CAD design. The simulation mechanism displays a master checklist of the user-checkable check indicators, integrated with simulation results of the CAD design.

An article of manufacture of an embodiment of the invention includes a computer-readable medium and means in the medium. The means is for displaying changes to elements of a CAD design in a highlighted manner, as well as check indicators corresponding to the changes that denote whether the changes have been user reviewed. The means may also be for displaying a dynamically updated completion ratio of the check indicators that have been checked by a user, as well as a master checklist of the user-checkable indicators integrated with simulation results of the CAD design.

Embodiments of the invention provide for advantages over the prior art. The goal of paperless design is more easily obtainable using the invention. This is because paper copies of a design do not have to be marked up with modifications, which are then reviewed or verified before reentry into a CAD system. Rather, the modifications can be entered directly into the CAD system, where the changes are highlighted, and a mechanism provided in which the changes are indicated as being reviewed via check indicators. Still other advantages, aspects, and embodiments of the invention will become apparently by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of an example computer-aided drafting (CAD) design being displayed by a CAD system, according to an embodiment of the invention.

FIG. 2 is a diagram of an example master checklist that has CAD design changes integrated with simulation results of the CAD design, according to an embodiment of the invention.

FIG. 3 is a block diagram of a rudimentary CAD system, according to an embodiment of the invention.

FIG. 4 is a flowchart of a representative method of the workflow involving a CAD system, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

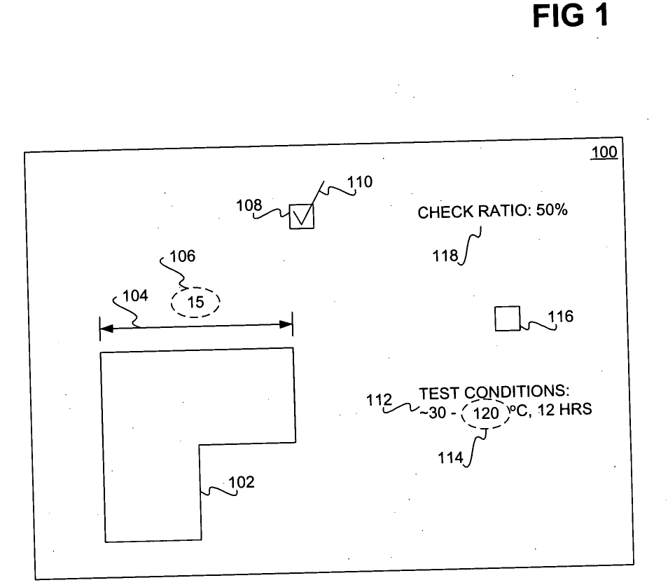

FIG. 1 shows an example display of a computer-aided drafting (CAD) design 100 being displayed by a CAD system, according to an embodiment of the invention. The display 100 includes two elements 102 and 112. The element 102 is an actual part of the design 100, whereas the element 112 represents test conditions under which the design 100 is to be tested. The elements 102 and 112 have corresponding changes 106 and 114 that have been made to them. The change 106 represents a change to the dimension 104, whereas the change 114 represents a change to the upper limit of the temperature range of the test conditions. As can be appreciated by those of ordinary skill within the art, the elements 102 and 112 are depicted as examples of the types of elements that can be included within the CAD design 100, and are not intended to be exhaustive.

The changes 106 and 114 may be user initiated, simulation initiated, or initiated in another manner. For instance, a user may initiate the changes 106 and 114, by manually entering the changes 106 and 114. As another example, the changes 106 and 114 may be initiated by simulation. A computer-aided engineering (CAE) system may be run that recommends the changes 106 and 114, such that a user may then have to review the changes 106 and 114 recommended by the CAE system.

The changes 106 and 114 to the elements 102 and 112 preferably are displayed in a highlighted manner, as indicated in FIG. 1 specifically by dotted lines. The highlighted manner may be bolding of the changes 106 and 114, coloring them, such as in yellow or in red, and so on. Furthermore, the changes 106 and 114 have associated check indicators 108 and 116. The check indicators 108 and 116 are user checkable, to denote that a user has checked and approved the changes 106 and 114 with which they are associated. As depicted in FIG. 1, the check indicators 108 and 116 are boxes, but in other embodiments may be other types of shapes. The check indicator 108 has been checked with a checkmark 110, indicating that a user has reviewed the change 106 associated with the check indicator 108. By comparison, the check indicator 116 has not been checked with a checkmark, indicating that a user has not reviewed the change 114.

Furthermore, the design 100 is preferably displayed with a dynamically updated completion ratio 118 of the check indicators that have been checked by the user. For instance, in the example of FIG. 1, there are two check indicators 108 and 116, where just one, the check indicator 108, has been checked with the checkmark 108. Therefore, the completion ratio 118 indicates 50%. The completion ratio 118 is dynamically updated in that, as a user checks or un-checks the check indicators 108 and 116, the completion ratio 118 is automatically updated to indicate the new percentage ratio. For instance, if the indicator 108 were to be un-checked, then the ratio 118 would drop to 0%. Conversely, if the indicator 116 were checked, then the ratio 118 would increase to 100%.

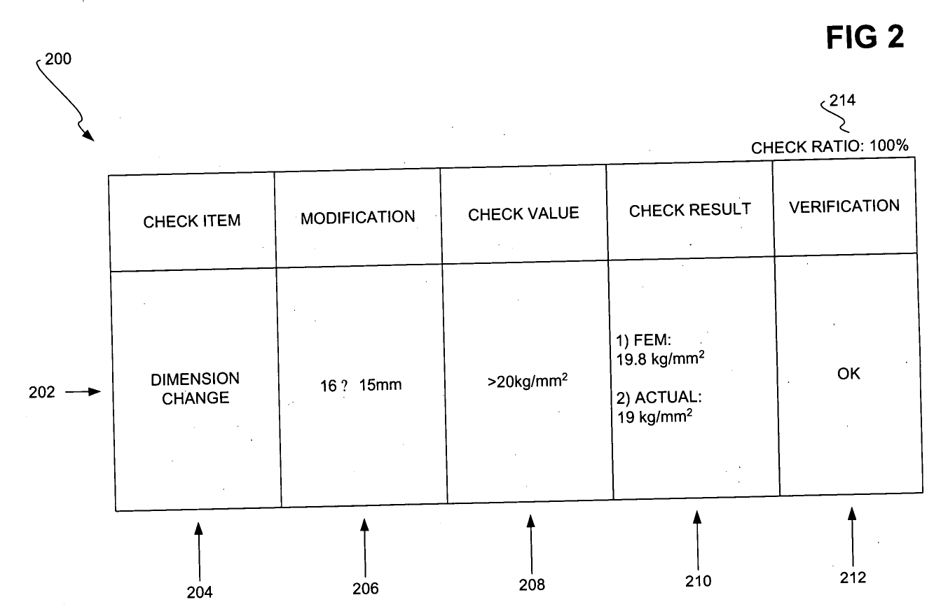

FIG. 2 shows a master checklist 200 of user-checkable check indicators that is integrated with the simulation results of a CAD design, by a CAE system, according to an embodiment of the invention. For sake of illustrative simplicity, a single entry 202 is depicted in the master checklist 200, which corresponds to the change 106 of the CAD design 100 of FIG. 1. The master checklist 200 would thus include entries for all of the changes within a CAD design in an actual implementation, such as the change 114 of the CAD design 100 in addition to the change 106.

The columns 204 and 206 of the master checklist 200 relate to the changes of the CAD design. With respect to the entry 202, the column 204 indicates the type of change that has been made, such as a dimension change, the column 206 indicates the modification or change that has actually been made, such as a change from 16 to 15 millimeters. By comparison, the columns 208, 210, and 212 of the master checklist 200 relate to the simulation of the CAD design. With respect to the entry 202, the column 208 relates to a value that is to be checked by simulation, whereas the column 210 relates to the actual results of this value, and the column 212 indicates whether this value is OK.

That the columns 204 and 206 of the master checklist 200 relate to the changes of the CAD design, and the columns 208, 210, and 212 relate to the simulation of the CAD design, show how user-checkable check indicators—which correspond to the changes—are integrated with the simulation results of the CAD design. Furthermore, a dynamically updated completion ratio 214 is also depicted along with the master checklist 200. The completion ratio 214 thus is the same ratio as the ratio 118 of FIG. 1, although the ratio 214 indicates 100% to denote that a user has reviewed all of the changes.

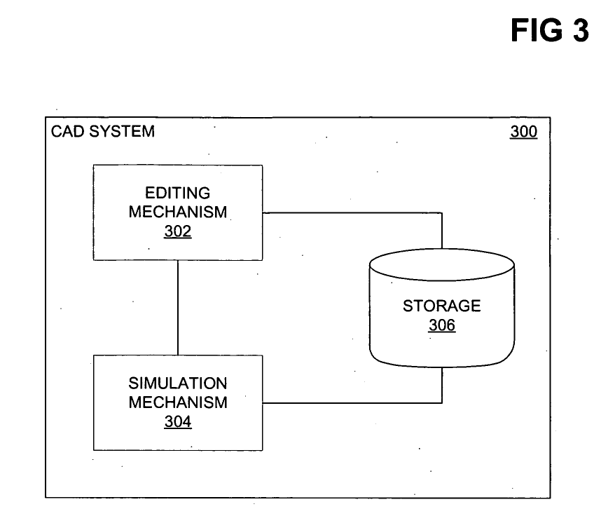

FIG. 3 shows a rudimentary CAD system 300, according to an embodiment of the invention. The CAD system 300 includes an editing mechanism 302, a simulation mechanism 304, and a storage 306. Each of the mechanisms 302 and 304 may be software, hardware, or a combination of software and hardware. The storage 306 may be a magnetic medium, such as a hard disk drive, or another type of storage. The storage 306 is for storing CAD designs, like the CAD design 100 of FIG. 1, results of simulations of the CAD designs, and so on.

The editing mechanism 302 allows a user to add, delete, and modify elements of a CAD design, such as the CAD design 100 of FIG. 1. The editing mechanism 302 provides for displaying changes to the elements of the CAD design in a highlighted manner, as well as for displaying user-checkable check indicators corresponding to the changes that denote whether the changes have been-reviewed, as described in relation to FIG. 1. Furthermore, the editing mechanism 302 may display a dynamically updated completion ration of the check indicators that have been checked by a user. But for the inventive aspects of the editing mechanism 302, the editing mechanism 302 may be implemented as a conventional CAD editing mechanism, as can be appreciated by those of ordinary skill within the art. That is, the manner by which the CAD editing mechanism 302 provides for adding, deleting, and modifying elements of a CAD design may be in accordance with existing CAD systems.

The simulation mechanism 304 provides for simulating a CAD design. The simulation mechanism 304 may be a CAE system or sub-system. Furthermore, the simulation mechanism 304 displays a master checklist of the user-checkable check indicators integrated with the simulation results of the CAD design, as has been described in relation to FIG. 2. The simulation mechanism 304 may also display a dynamically updated completion ratio of the check indicators that have been checked by the user. But for the inventive aspects of the simulation mechanism 304, the simulation mechanism 304 may be implemented as a conventional CAD simulation mechanism, or a conventional CAE simulation mechanism, as can be appreciated by those of ordinary skill within the art. That is, the manner by which the simulation mechanism 304 provides for simulation of a CAD design may-be in accordance with existing CAD or CAE systems.

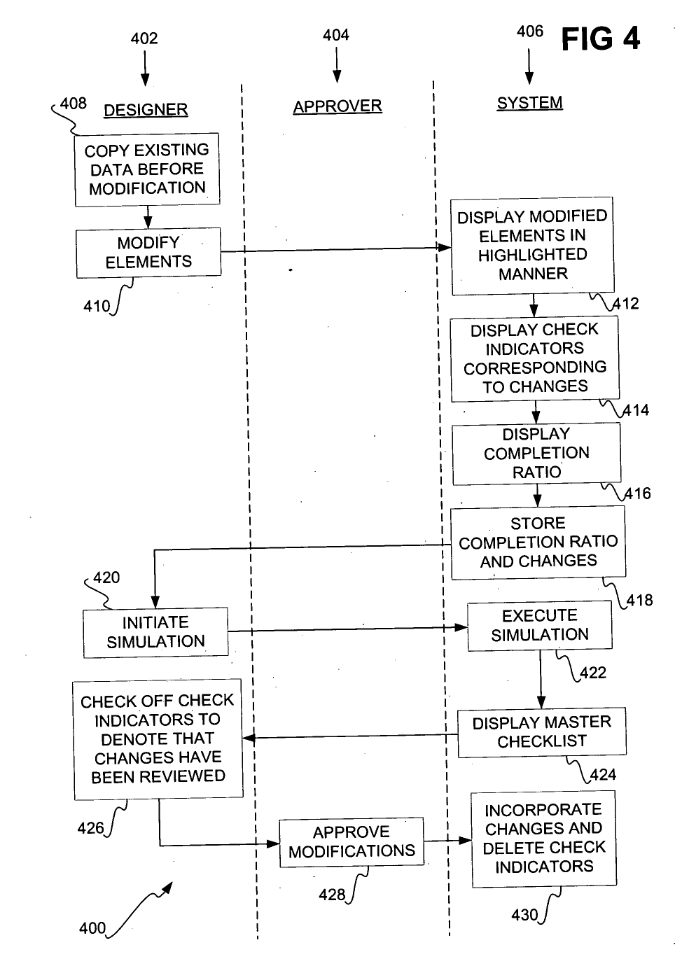

FIG. 4 shows a representative method 400 of the workflow of a CAD system, such as the CAD system 300 of FIG. 3, according to an embodiment of the invention. Different parts of the method 400 are performed by a designer 402, an approver 404, and a CAD system 406, as denoted in FIG. 3. The parts of the method 400 performed by the CAD system 406 may be implemented as a computer program stored oh a computer-readable medium of an article of manufacture. The computer-readable medium may be a recordable data storage medium, a modulated carrier signal, or another type of computer-readable medium.

First, the designer 402 copies existing data for a CAD design, such as the CAD design 100 of FIG. 1, to create a new copy for modification purposes, in conjunction with the CAD system 406 (408). The designer 402 then modifies elements of the CAD design as desired, where such modification is permitted and provided for by the CAD system 406 (410). The CAD system 406 itself displays the modified elements in a highlighted manner (412), displays check indicators corresponding to the changes made to these elements (414), and displays a dynamically updated completion ratio of the check indicators that have been checked by the designer 402 (416), as has been described. The CAD system 406 further stores the completion ratio, the changes made to the elements of the CAD design, and the CAD design itself (418).

At some point, the designer 402 initiates simulation of the CAD design in question (420). The CAD system 406 thus executes the simulation (422). It is noted that the simulation itself may result in changes to elements of the CAD design, in one embodiment of the invention. The CAD system 406 displays a master checklist, within which the results of the simulation of the CAD design are integrated (424), as has been described. The designer 402 is then afforded the opportunity to check off the check indicators to denote that the changes that were made to the elements of the CAD design have been reviewed (426), as has also been described. Once the approver 404 has approved the CAD design, including the modifications made to the elements thereto (428), the CAD system 406 incorporates the changes into the final CAD design, and deletes the check indicators from the CAD design (430).

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of embodiments of the present invention. It is manifestly intended that this invention be limited only by the claims and equivalents thereof.

What is claimed is:

1. A method comprising:
displaying in a highlighted manner a change to an element of a computer-aided drafting (CAD) design;
displaying a check indicator denoting whether the change to the element has been reviewed; and,
permitting a user to check the check indicator to denote that the change to the element has been reviewed.

2. The method of claim 1, further comprising displaying a dynamically updated completion ratio of a plurality of check indicators that have been checked by the user.

3. The method of claim 2, further comprising, upon approval of the CAD design, deleting the plurality of check indicators from the CAD design.

4. The method of claim 2, further comprising storing the completion ratio of the plurality of check indicators and a plurality of changes of the CAD design to which the plurality of check indicators correspond.

5. The method of claim 2, further comprising displaying the plurality of check indicators within a master checklist.

6. The method of claim 5, further comprising executing a simulation of the CAD design, such that the plurality of check indicators displayed within the master checklist are integrated with results of the simulation of the CAD design.

7. The method of claim 1, further comprising initially permitting the user to modify the element of the CAD design to make the change thereto.

8. The method of claim 1, further comprising, upon approval of the CAD design, permanently incorporating the change to the element of the CAD design.

9. The method of claim 1, further comprising, upon approval of the CAD design, deleting the check indicator from the CAD design.

10. The method of claim 1, further comprising executing a simulation of the CAD design, such that the change to the element of the CAD design results from the simulation.

11. A computer-aided drafting (CAD) system comprising:
an editing mechanism to add, delete, and modify elements of a CAD design, the editing mechanism displaying changes to the elements in a highlighted manner, and displaying user-checkable check indicators corresponding to the changes that denote whether the changes have been user reviewed; and,
a simulation mechanism to simulate the CAD design, the simulation mechanism displaying a master checklist of the user-checkable check indicators integrated with simulation results of the CAD design.

12. The CAD system of claim 11, wherein the editing mechanism further displays a dynamically updated completion ratio of the check indicators that have been checked by a user.

13. The CAD system of claim 11, wherein the simulation mechanism further displays a dynamically updated completion ratio of the check indicators that have been checked by a user.

14. The CAD system of claim 11, wherein the changes to the elements comprise user-initiated change elements.

15. The CAD system of claim, wherein the changes to the elements comprise simulation-initiated change elements.

16. An article of manufacture comprising:
a computer-readable medium; and,
means in the medium for displaying changes to elements of a computer-aided drafting (CAD) design in a highlighted manner and check indicators corresponding to the changes that denote whether the changes have been user reviewed.

17. The article of claim 16, wherein the means is further for displaying a dynamically updated completion ratio of the check indicators that have been checked by a user.

18. The article of claim 16, further comprising means for displaying a master checklist of the user-checkable indicators integrated with simulation results of the CAD design.

19. The article of claim 18, wherein the means for displaying the master checklist further is for displaying a dynamically updated completion ratio of the check indicators that have been checked by a user.

20. The article of claim 16, wherein the computer-readable medium is one of a recordable data storage medium and a modulated carrier signal.
